(19) United States
(12) Patent Application Publication
(10) Pub. No.: US 2024/0015261 A1
(43) Pub. Date: Jan. 11, 2024

(54) VIDEO TELECONFERENCING

(71) Applicant: Bose Corporation, Framingham, MA (US)

(72) Inventors: Alexander Decastro Calachan, Cambridge, MA (US); Ethan J. Colburn, Pepperell, MA (US); Lee M. Jones, Austin, TX (US); Richard Lionel Lanoue, III, Whitinsville, MA (US); Lisa Lyman, Natick, MA (US); Joel H. Miller, Westborough, MA (US); Matthew C. Smith, Needham, MA (US); Sara Beth Ulius-Sabel, Northborough, MA (US); Tiantian Zhang, Framingham, MA (US); Brian David Mulcahey, Sudbury, MA (US)

(73) Assignee: Bose Corporation, Framingham, MA (US)

(21) Appl. No.: 18/038,163

(22) PCT Filed: Nov. 23, 2021
(86) PCT No.: PCT/US2021/060474

§ 371 Date: May 22, 2023

Related U.S. Application Data
(60) Provisional application No. 63/117,855, filed on Nov. 24, 2020.

(51) Int. Cl. H04N 7/14; H04N 7/15

(52) U.S. Cl. CPC H04N 7/142; H04N 7/15

(57) ABSTRACT

System (100) for accommodating mobile devices used for video teleconferencing, the system including a loudspeaker (120), a controller (190), and an elevated support (140) for the mobile device. The controller communicates with the mobile device and controls the loudspeaker to provide an audio interface with the mobile device.

### BACKGROUND

With the increase in working from home, such as due to the Covid-19 pandemic, video conferencing usage has increased substantially. In various cases, users at home may use a personal mobile device, such as a smart phone or tablet, as a video conferencing end point device, potentially providing audio, video, and control functionality. There exists a need for more convenient positioning, operation, control, and sound fidelity when using such devices.

### SUMMARY

Systems and methods disclosed herein are directed to audio and video conferencing systems, methods, and applications. In particular, systems and methods disclosed are directed to peripheral systems and methods that provide control systems and methods and audio systems and methods that inter-operate with other devices that may provide video systems and methods, such as a mobile device, smart phone, tablet, etc.

According to at least one aspect, an audio system is provided that includes a loudspeaker, a controller, and an elevated support to accommodate a mobile device, such as a smart phone, tablet, or the like. The controller receives first audio signals from the mobile device and controls the loudspeaker to produce acoustic signals based on the first audio signals.

Some examples include a microphone. The controller is configured to receive microphone signals from the microphone and to provide second audio signals to the mobile device based upon the microphone signals.

In certain examples, the support structure includes a cradle having a support surface and one or more footings. The microphone may be positioned on one of the one or more footings.

In some examples, the support structure includes an opening capable of accommodating a cable or wire, such as a charging cable or audio cable, to pass therethrough

In various examples, the one or more footings includes a flat surface, a curve, and an angled flat face, wherein the flat surface is substantially perpendicular to the support surface at one edge, the flat surface transitions to the curve at another edge, and the curve ends at the angled flat face, the angled flat face being not perpendicular to the flat surface and the angled flat face being not parallel to the support surface.

In some examples, the angled flat face is angled away from the support surface.

Various examples include a wireless charger associated with the support structure.

Some examples include a control puck having one or more user input sensors, the controller coupled to the control puck to receive user inputs from the control puck and to provide control messages to the mobile device. The control puck may be removable according to certain examples.

Some examples include a scroll wheel.

In certain examples, the support surface of the cradle has a rearward tilt of approximately 5 degrees.

In some examples, the audio device has a total height in a range of 250 millimeters to 360 millimeters.

In various examples, the elevated support structure has an adjustable height.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1A is a schematic front view of an example device;

FIG. 1B is a schematic side view of the example device of FIG. 1A;

FIG. 1C is a schematic rear view of the example device of FIG. 1A;

FIG. 2 is a perspective view of a portion of the example device of FIG. 1A;

FIG. 3 is a perspective view of another portion of the example device of FIG. 1A;

FIG. 4A is a perspective view of another portion of the example device of FIG. 1A;

FIG. 4B is a side view of the portion shown in FIG. 4A; and

FIG. 4C is a detail side view of a portion of FIG. 4B.

### DETAILED DESCRIPTION

Aspects of the present disclosure are directed to systems and methods suitable for use with a mobile and/or handheld device capable of participating in video and/or teleconferencing. Many individuals use a smart phone, tablet, or similar device to participate in video teleconferences, generally using a software application available for the device from a service provider.

The mobile device used in these instances typically includes hardware and software for capturing and displaying video, e.g., having a camera and a display screen, capturing and rendering audio. e.g., having at least one microphone and at least one speaker, and for controlling the user's interaction with the videoconference and/or application software, e.g., having a touchscreen or other user input means, to allow the user to operate such functions as joining and leaving the conference, muting the microphone or the speaker, starting and stopping video (incoming or outgoing), sharing content with other participants, etc.

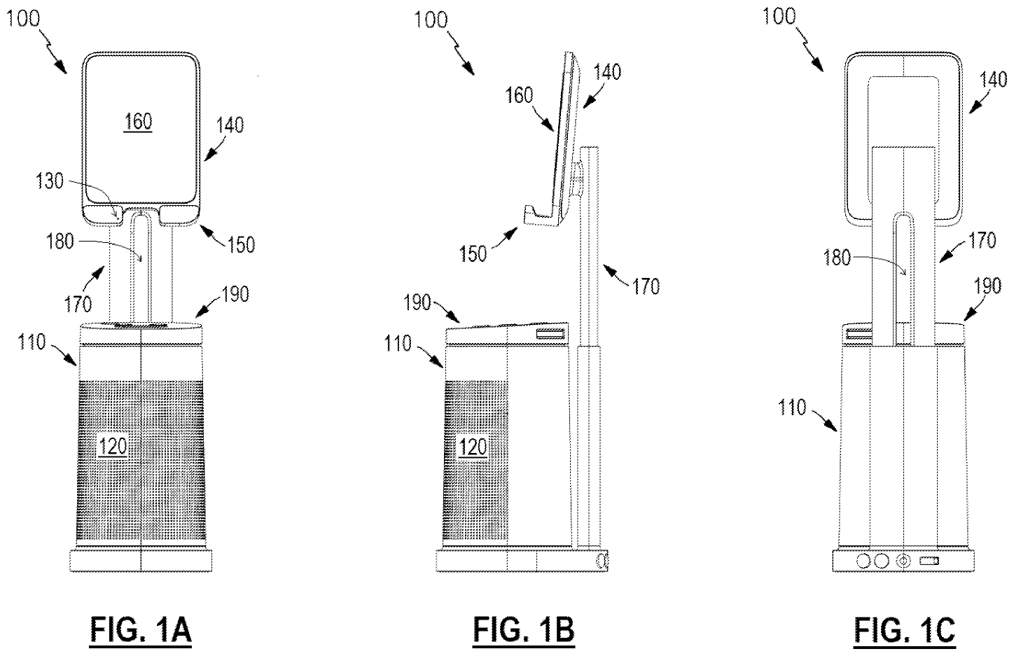

FIGS. 1A-1C illustrate a front, side, and rear view, respectively, of an example device 100 intended for use with a mobile device (e.g., a smart phone, tablet, or similar), to physically support the mobile device in a position useful for a user's participation in a video teleconference, to provide control inputs to the mobile device useful to control participation in the video teleconference, and to provide audio pick-up (microphone) to capture the user's voice and provide a microphone signal to the mobile device, and to render audio from the mobile device via a loudspeaker. While participation in a video conference may be described throughout this specification, systems and methods in accord with those described herein are not necessarily limited to video conferencing systems, and may be applicable to audio conferencing and/or other applications used on the mobile device with the benefit of the systems and methods herein, including the example system of device 100 and the methods implemented thereby.

The device 100 includes a main body 110 (or housing, or enclosure) enclosing a loudspeaker 120, which may be covered by a grille that allows acoustic energy, e.g., audio signals, from the loudspeaker 120 to be emitted out of at least a portion of the main body 110. The device 100 also includes a microphone 130. The device 100 is an audio device, capable of providing audio input and output, via the microphone 130 and the loudspeaker 120, respectively, to and from a mobile device. The device 100 includes various components to allow communications with a mobile device and may be coupled to the mobile device by one or more wired and/or wireless interfaces, such as by a Bluetooth® or equivalent wireless protocol. Additionally, the device 100 includes a controller (not explicitly shown) that manages the various audio input, audio output, and control inputs and outputs to and from the mobile device, including managing the communication interface with the mobile device.

According to various examples, the device 100 includes an elevated support structure for the mobile device, such as having a cradle 140 for supporting a mobile device. The cradle 140 includes at least one footing 150 and a support surface 160. In some examples, the support structure and/or the cradle 140 may have an adjustable height. According to certain examples, a top of the cradle 140 may be about 360 millimeters (mm) higher than a bottom or base of the audio device 100. In some examples, the top of the cradle 140 may be between about 240 mm and 360 mm higher than the bottom or base of the audio device 100.

In the illustrated example, the microphone 130 is located on a front facing portion of a footing 150. Accordingly, the microphone 130 is beneficially located away from the loudspeaker 120 (to reduce feedback or echo) and at a beneficial height and orientation to pick up the voice of a user when using the device 100.

The cradle 140 is supported from the main body 110, or a base thereof, by a spine 170. In various examples, the spine 170 may include an open slot 180.

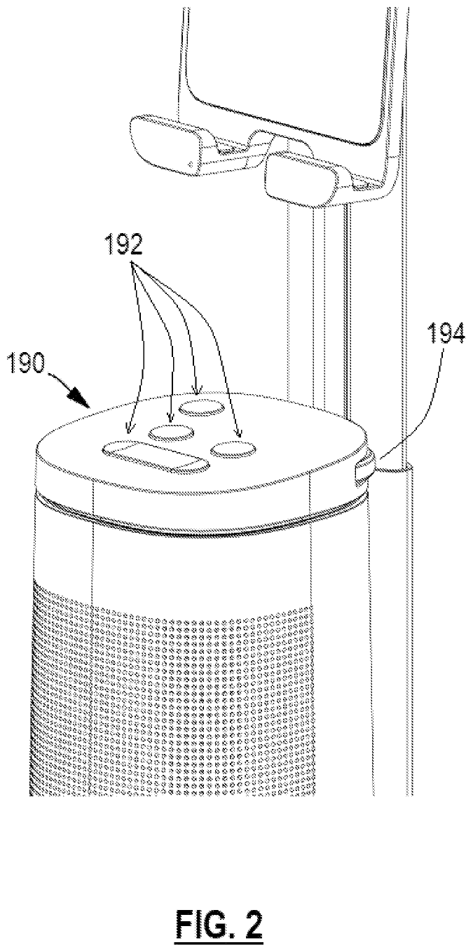

The device 100 is also, according to certain examples, a control device equipped with sensor(s) to detect user input and upon which control signals may be exchanged with the mobile device. The illustrated example device 100 includes a control puck 190, having various sensors, buttons, or the like to detect user input upon which the controller may provide appropriate control signals to the mobile device. In various examples, the control puck 190 may be removable from the main body 110. FIG. 2 illustrates a closer perspective view of a portion of the device 100. In FIG. 2, various buttons 192 and a scroll wheel 194, each associated with the control puck 190, are visible. Other examples may include different types of sensors for control inputs, and the sensors may be located elsewhere in some examples. Sensors may include physical buttons, touch-sensitive surfaces, scroll wheels, proximity sensors, or any other type of sensor suitable for detecting user actions, interactions, movements, gestures, and the like.

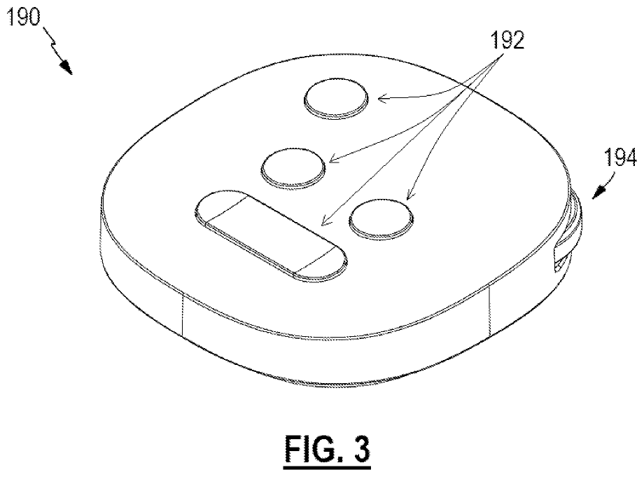

FIG. 3 illustrates yet another view of the control puck 190, in this case removed from the main body 110. The various buttons 192 (or other sensors) may be programmed to cause the controller to send control signals to the mobile device to perform various functions, such as may be functions or features of an application running on the mobile device. Examples include muting or unmuting the microphone 130, turning on or off outgoing video, turning on or off incoming video, adjusting volume up or down, a “panic” function (a “panic” function may, for instance, carry out numerous emergency actions, such as muting the microphone 130 and turning off the outgoing video with one press), or other functions or actions. In various examples, each of the buttons 192 (or other sensors) may have pre-defined functions, may have user-configurable functions, and/or may have application specific functions depending upon the mobile device. For example, when using video teleconferencing software on the mobile device, a certain button 192 may turn off the outgoing video, but when using a music streaming application on the mobile device, the same button 192 may skip tracks.

For the example device 100, the control puck 190 also includes a scroll wheel 194, which may provide user input for various pre-configured, user-configured, or application specific actions. For example, rotating the scroll wheel 194 clockwise may increase volume while rotating the scroll wheel 194 counter-clockwise may decrease the volume. In some instances, the scroll wheel 194 may be linked to a selection displayed on the mobile device, such as scrolling through a menu or a list of options. The scroll wheel 194 may include a button 192, such that when the scroll wheel 194 is depressed lightly by the user, a selection is made and/or a function or action is activated or taken.

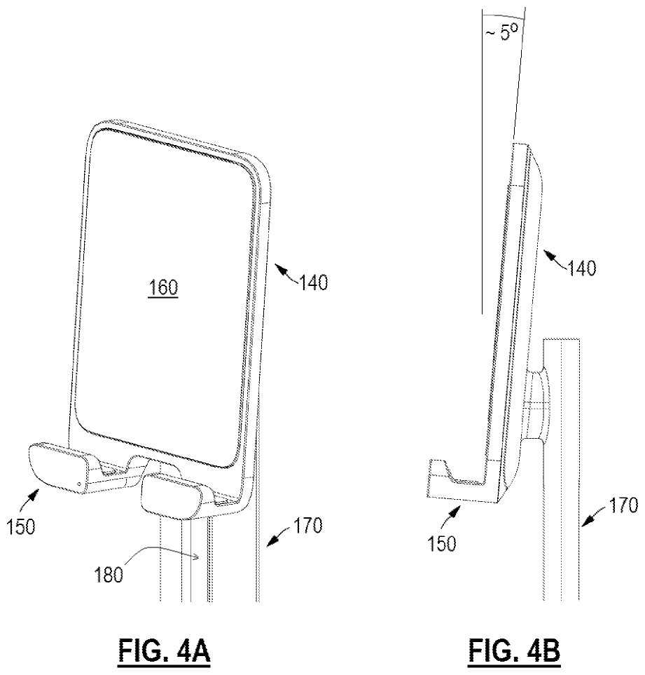

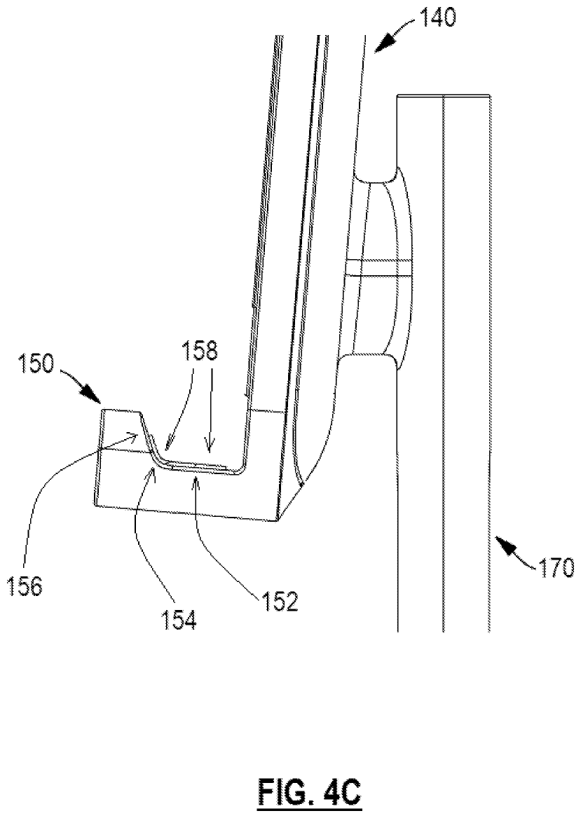

FIG. 4A illustrates a closer perspective view of a different portion of the device 100, and in particular illustrates the cradle 140 and spine 170. The cradle 140 includes one or more footings 150. In the instant example device 100, the cradle 140 includes two footings 150 separated by a gap. The cradle 140 also includes a support surface 160. The spine 170 includes an open slot 180. In various examples, the device 100 accommodates providing power to a mobile device when in use. In certain examples, the device 100 may include wireless charging components behind the support surface 160. For example, the cradle 140 may include a wireless charger in compliance with any of various wireless charging standards, such as from the Wireless Power Consortium, Inc.

Additionally, the open slot 180 in combination with the gap between the footings 150 accommodates wired charging of a mobile device, by providing a pathway to a bottom edge of the mobile device for wire routing.

In various examples, at least a portion of the support surface 160 may be coated with a non-slip coating, such as a rubber-like or silicone material.

With reference to FIG. 4B, in certain examples, the cradle 140 may have a rearward tilt of about 5 degrees. Thereby the cradle 140 may hold the mobile device securely without the need for a clamp or other locking mechanism. Such a rearward tilt of about 5 degrees maintains physical stability, provided an ergonomic viewing angle, as well as a flattering camera angle. In various use cases, a camera is provided in the mobile device.

With reference to FIG. 4C, in various examples, each of the one or more footings 150 has a flat surface 152, substantially perpendicular to the support surface 160 of the cradle 140, upon which an edge of the mobile device will rest when in use. The flat surface 152 transitions to a curve 154 which ends at an angled flat face 156. The flat surface 152 allows for curved and V-shape profiled mobile devices to not fall forward. And the curve 154 and angled flat face 156 allow for thick cases to wedge into the cradle 140, again without falling forward.

At least a portion of each of the flat surface 152, curve 154, and angled flat face 156 is covered by a non-slip coating 158, such as a rubber-like or silicone material. The non-slip coating 158, in combination with the substantially perpendicular angle between the flat surface 152 and the support surface 160, accommodates squared-edge mobile devices, retaining such mobile devices in place without the mobile device slouching or sliding forward.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples.” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including.” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An audio device comprising:
a loudspeaker;
a controller coupled to the loudspeaker; and
an elevated support structure including a cradle comprising a support surface and one or more footings configured to accommodate a mobile device,
wherein the controller is configured to communicate with the mobile device, to receive first audio signals from the mobile device, and to control the loudspeaker to produce acoustic output based upon the first audio signals.

2. The audio device of claim 1 further comprising a microphone, wherein the controller is further coupled to the microphone and configured to receive microphone signals from the microphone and to provide second audio signals to the mobile device based upon the microphone signals.

3. The audio device of claim 1 wherein the support structure comprises an opening capable of accommodating a cable or wire to pass therethrough.

4. The audio device of claim 1 wherein the microphone is positioned on one of the one or more footings.

5. The audio device of claim 1 wherein the one or more footings includes a flat surface, a curve, and an angled flat face, wherein the flat surface is substantially perpendicular to the support surface at one edge, the flat surface transitions to the curve at another edge, and the curve ends at the angled flat face, the angled flat face being not perpendicular to the flat surface and the angled flat face being not parallel to the support surface.

6. The audio device of claim 5 wherein the angled flat face is angled away from the support surface.

7. The audio device of claim 1 further comprising a wireless charger associated with the support structure.

8. The audio device of claim 1 further comprising a control puck having one or more user input sensors, the controller coupled to the control puck to receive user inputs from the control puck and to provide control messages to the mobile device.

9. The audio device of claim 8 wherein the control puck is removable.

10. The audio device of claim 1 further comprising a scroll wheel.

11. The audio device of claim 1 wherein the support surface of the cradle has a rearward tilt of approximately 5 degrees.

12. The audio device of claim 1 wherein the audio device has a total height in a range of 250 millimeters to 360 millimeters.

13. The audio device of claim 1 wherein the elevated support structure has an adjustable height.
